(19) United States
(12) Patent Application Publication
(10) Pub. No.: US 2024/0126573 A1
(43) Pub. Date: Apr. 18, 2024

(54) DISPLAY CONTROL DEVICE, DISPLAY CONTROL METHOD, AND DISPLAY CONTROL PROGRAM

(71) Applicant: Nippon Telegraph and Telephone Corporation, Tokyo (JP)

(72) Inventors: Taisuke WAKASUGI, Musashino-shi, Tokyo (JP); Tomonori MORI, Musashino-shi, Tokyo (JP); Masashi Tadokoro, Musashino-shi, Tokyo (JP); Akira KATAOKA, Musashino-shi, Tokyo (JP); Haruo OISHI, Musashino-shi, Tokyo (JP)

(21) Appl. No.: 18/278,145

(22) PCT Filed: Feb. 26, 2021
(86) PCT No.: PCT/JP2021/007437

§ 371 Date: Aug. 21, 2023

(51) Int. Cl. G06F 9/451; G06F 3/04847

(52) U.S. Cl. CPC G06F 9/451; G06F 3/04847

(57) ABSTRACT

A display control device (10) includes: a first acquisition unit (151a) configured to acquire information regarding an existing UI; an extraction unit (151b) configured to extract a rule set indicating relevance between the existing UI and an extended UI from a predetermined database based on the information regarding the existing UI acquired by the first acquisition unit (151a); a first generation unit (151c) configured to generate rule information of the extended UI based on the rule set extracted by the extraction unit (151b); and a setting unit (152) configured to set display of the extended UI based on the rule information of the extended UI generated by the first generation unit (151c).

### TECHNICAL FIELD

The present invention relates to a display control device, a display control method, and a display control program.

### BACKGROUND ART

In the related art, there is a user interface (UI) extension technology for realizing an improvement in productivity of an operator by adding a function extension such as input check and automation to a web screen without modifying a system. A feature of this UI extension technology is to newly add a UI for function extension (extended UI) to a screen without modifying a UI originally present on the system screen (existing UI). Various functions can be extended by setting an operation for cooperation between an existing UI and an extended UI. For example, when a “button” is clicked as an extended UI, a value is automatically input to a “text box” which is an existing UI.

### CITATION LIST

### Patent Literature

Patent Literature 1: JP 2017 072872 A

### SUMMARY OF INVENTION

### Technical Problem

However, in the above-described conventional technology, it is not possible to automatically generate or display an appropriate UI on a new web system screen, and it is not possible to improve productivity and efficiency of a rule setting. This is because there are problems to be described below in the technology of the related art.

In a user interface (UI) enhancement technology of the related art, various function extension settings are possible. However, when the UI extension is applied to a new web page, knowledge and experience of a past rule setting may not be employed, it is necessary to set the rule manually from zero each time, which is difficult for a user with little experience. This is because, in the technology of the related art, a rule and a web page have one-to-one correspondence and the generated rule cannot be applied to other web pages (see FIG. 7).

### Solution to Problem

In order to solve the above-described problems and achieve the objective, according to an aspect of the present invention, a display control device includes: a first acquisition unit configured to acquire information regarding an existing UI; an extraction unit configured to extract a rule set indicating relevance between the existing UI and an extended UI from a predetermined database based on the information regarding the existing UI acquired by the first acquisition unit; a first generation unit configured to generate rule information of the extended UI based on the rule set extracted by the extraction unit; and a setting unit configured to set display of the extended UI based on the rule information generated by the first generation unit.

According to another aspect of the present invention, a display control method is executed by a display control device. The method includes: a first acquisition step of acquiring information regarding an existing UI; an extraction step of extracting a rule set indicating relevance between the existing UI and an extended UI from a predetermined database based on the information regarding the existing UI acquired in the first acquisition step; a first generation step of generating rule information of the extended UI based on the rule set extracted in the extraction step; and a setting step of setting display of the extended UI based on the rule information generated in the first generation step.

According to still another aspect of the present invention, a display control program causes a computer to execute: a first acquisition step of acquiring information regarding an existing UI; an extraction step of extracting a rule set indicating relevance between the existing UI and an extended UI from a predetermined database based on the information regarding the existing UI acquired in the first acquisition step; a first generation step of generating rule information of the extended UI based on the rule set extracted in the extraction step; and a setting step of setting display of the extended UI based on the rule information generated in the first generation step.

### Advantageous Effects of Invention

According to the present invention, it is possible to improve productivity and efficiency of a rule setting of an extended UI.

### BRIEF DESCRIPTION OF DRAWINGS

FIG. 1 is a diagram illustrating an exemplary configuration of a display control system according to a first embodiment.

FIG. 2 is a block diagram illustrating an exemplary configuration of a display control device according to the first embodiment.

FIG. 3 is a diagram illustrating an example of a UI information determination process according to the first embodiment.

FIG. 4 is a diagram illustrating an example of a UI information updating process according to the first embodiment.

FIG. 5 is a flowchart illustrating an example of a flow of a display control process according to the first embodiment.

FIG. 6 is a diagram illustrating a computer that executes a program.

FIG. 7 is a diagram illustrating a display control process of the related art.

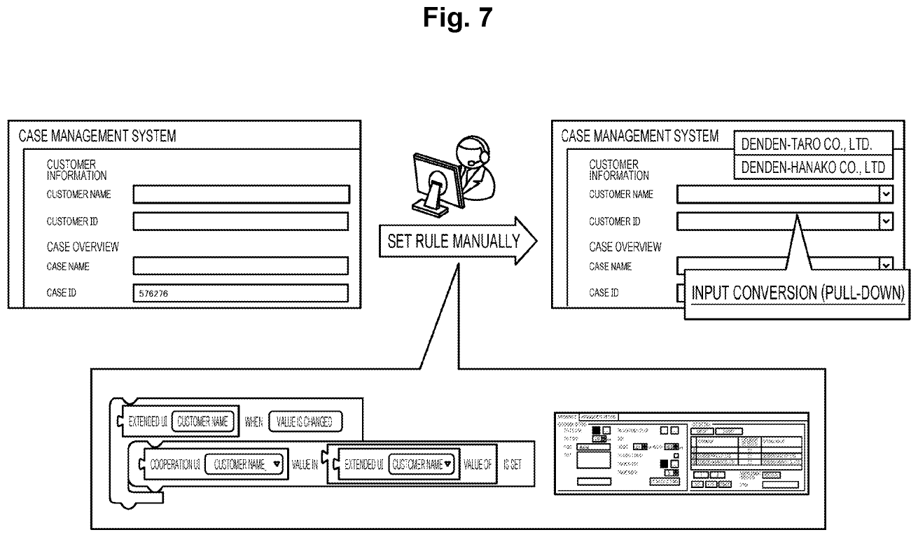

### DESCRIPTION OF EMBODIMENTS

Hereinafter, embodiments of a display control device, a display control method, and a display control program according to the present invention will be described in detail with reference to the drawings. The present invention is not limited to the embodiments to be described below.

### First Embodiment

Hereinafter, a configuration of a display control system, a configuration of a display control device, a UI information determination process, a UI information update process, and a flow of a display control process according to a first embodiment (fittingly, the present embodiment) will be sequentially described, and finally, advantageous effects of the present embodiment will be described.

### [Configuration of Display Control System]

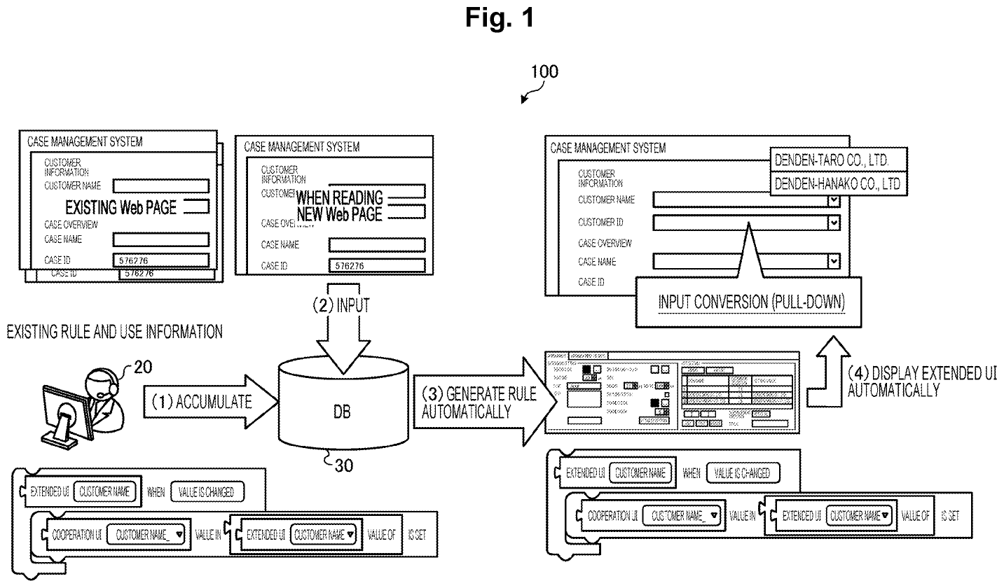

A configuration of a display control system (fittingly, the present system) 100 according to the present embodiment will be described in detail with reference to FIG. 1. FIG. 1 is a diagram illustrating an exemplary configuration of a display control system according to the first embodiment. The present system 100 includes a display control device 10 (not illustrated), a user 20, and a database (DB) 30. Here, the display control device 10, the user 20, and the database 30 are communicably connected in a wired or wireless manner via a predetermined communication network (not illustrated). The display control system 100 illustrated in FIG. 1 may include a plurality of users 20 and a plurality of databases 30.

First, various types of information necessary to generate a rule of an extended UI are accumulated in the database 30 by inputting an existing rule and use information of the user 20 (see FIG. 1 (1)). Next, the new web page is read by the display control device 10 (not illustrated), and information of the existing UI included in the page is acquired and compared with the information of the database 30 (see FIG. 1 (2)). Then, the rule information of the extended UI to be applied to the existing UI of the new web page is automatically generated (see FIG. 1 (3)). Finally, the extended UI is automatically displayed on the screen by using the generated rule information of the extended UI (see FIG. 1 (4)).

In FIG. 1, a rule of an extended UI that executes pull-down is applied to a text box of an existing UI of “customer name” on a screen of “case management system” which is a new web page, and pull-down input of “DENDEN-TARO Co., Ltd.” and “DENDEN-HANAKO Co., Ltd.” is enabled. In the present system, the rule information of the automatically generated extended UI can be reflected in the database 30 as an existing rule.

In the display control system 100 according to the present embodiment, relevance between the existing UI and the extended UI can be structured and accumulated. When the new web system screen is read, a user interface (UI) that has high usability, that is, an appropriate user interface (UI), is automatically generated and displayed based on the UI information which has been accumulated so far. As described above, by enabling automatic generation and automatic display of an appropriate UI on the new web system screen, it is possible to dramatically improve productivity and efficiency of the rule setting.

### [Configuration of Display Control Device]

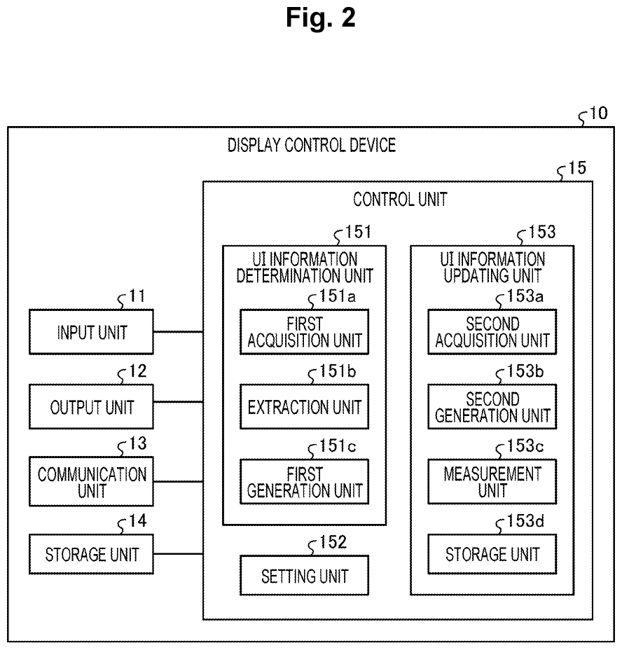

A configuration of the display control device 10 according to the present embodiment will be described in detail with reference to FIG. 2. FIG. 2 is a block diagram illustrating an exemplary configuration of the display control device according to the present embodiment. The display control device 10 includes an input unit 11, an output unit 12, a communication unit 13, a storing unit 14, and a control unit 15.

The input unit 11 is responsible for inputting various types of information to the display control device 10. The input unit 11 is, for example, a mouse, a keyboard, or the like, and receives an input of setting information or the like for the display control device 10. Further, the output unit 12 is responsible for outputting various types of information from the display control device 10. The output unit 12 is, for example, a display or the like, and outputs setting information or the like stored in the display control device 10.

The communication unit 13 is responsible for managing data communication with other devices. For example, the communication unit 13 performs data communication with each communication device. The communication unit 13 can perform data communication with a terminal of an operator (not illustrated).

The storing unit 14 stores various types of information referred to when the control unit 15 operates, and stores various types of information acquired when the control unit 15 operates. Here, the storing unit 14 is, for example, a semiconductor memory element such as a random access memory (RAM) or a flash memory, a storage device such as a hard disk or an optical disc, or the like. In the example of FIG. 2, the storing unit 14 is installed inside the display control device 10, but may be installed outside of the display control device 10, or a plurality of storing units may be installed.

The control unit 15 is responsible for controlling the entire display control device 10. The control unit 15 includes a first acquisition unit 151a, an extraction unit 151b, and a first generation unit 151c as the UI information determination unit 151. The control unit 15 includes a setting unit 152. Further, the control unit 15 includes, as the UI information updating unit 153, a second acquisition unit 153a, a second generation unit 153b, a measurement unit 153c, and a storage unit 153d. Here, the control unit 15 is, for example, an electronic circuit such as a central processing unit (CPU) or a micro processing unit (MPU), or an integrated circuit such as an application specific integrated circuit (ASIC) or a field programmable gate array (FPGA).

The first acquisition unit 151a acquires information regarding the existing UI. For example, the first acquisition unit 151a acquires UI types and label information of a plurality of existing UIs included in a new web page as information of the existing UI. On the other hand, the first acquisition unit 151a may store the acquired various types of information in the storing unit 14.

The extraction unit 151b extracts a rule set indicating relevance between the existing UI and the extended UI from the predetermined database 30 based on the information of the existing UI acquired by the first acquisition unit 151a. For example, the extraction unit 151b acquires, as a rule set, information regarding a specific existing UI, a UI type of extended UI, and arrangement information associated with the information of the specific existing UI. Furthermore, the extraction unit 151b extracts a rule set from a dedicated database shared by a plurality of users 20 as the predetermined database 30. The extraction unit 151b extracts, as the information regarding the existing UI acquired by the first acquisition unit 151a, a rule set in which a use frequency is the highest from the rule set group in which the label information is matched. On the other hand, the extraction unit 151b may store the extracted various types of information in the storing unit 14.

The first generation unit 151c generates the rule information of the extended UI based on the rule set extracted by the extraction unit 151b. For example, the first generation unit 151c generates the rule information of the extended UI based on the rule set to which the use frequency equal to or greater than the predetermined value is assigned. The first generation unit 151c generates, as the rule information of the extended UI, information in which information regarding an appropriate extended UI is associated with a plurality of existing UIs of the new web page from the plurality of extracted rule sets. On the other hand, the first generation unit 151c may store the various types of generated information in the storing unit 14.

The setting unit 152 sets the display of the extended UI based on the rule information of the extended UI generated by the first generation unit 151c. When the rule information of the extended UI generated by the first generation unit 151c is not uniquely determined, the setting unit 152 sets non-display of the extended UI or presentation of a selectable extended UI. For example, when there is a plurality of rule sets of which the use frequency is the highest in the rule set group that has the same label information of the existing UI extracted by the extraction unit 151b, the setting unit 152 presents the UI type of extended UI of which non-display or display of the extended UI is possible.

The second acquisition unit 153a acquires information regarding the existing UI and rule information of the extended UI. For example, the second acquisition unit 153a acquires UI types and label information of a plurality of existing UIs included in a web page as information of the existing UI. The second acquisition unit 153a acquires, as the rule information of the extended UI, information in which information regarding an appropriate extended UI is associated with a plurality of existing UIs of the web page. On the other hand, the second acquisition unit 153a may store the various types of acquired information in the storing unit 14.

The second generation unit 153b generates a rule set based on the information of the existing UI and the rule information of the extended UI acquired by the second acquisition unit 153a. For example, the second generation unit 153b generates a rule set for each piece of label information of the existing UI from the of UI types of a plurality of existing UIs and the label information included in the web page, and the information regarding the extended UI associated with the plurality of existing UIs of the web page. On the other hand, the second generation unit 153b may store the generated various types of information in the storing unit 14.

The measurement unit 153c measures the use frequency of the rule set based on an operation on the extended UI of which display is set by the setting unit 152. For example, the measurement unit 153c detects a user operation related to the UI type of extended UI of which display is set, and adds the use frequency of the rule set of the extended UI related to the detected operation by 1 for each user operation. On the other hand, the measurement unit 153c may store various pieces of measured information in the storing unit 14.

The storage unit 153d stores the rule set generated by the second generation unit 153b in the predetermined database 30. For example, the storage unit 153d stores the rule set to which the use frequency is assigned. The storage unit 153d may add the use frequency measured by the measurement unit 153c to the use frequency of the same rule set stored in the database 30 to update the use frequency of the rule set.

### [UI Information Determination Processing]

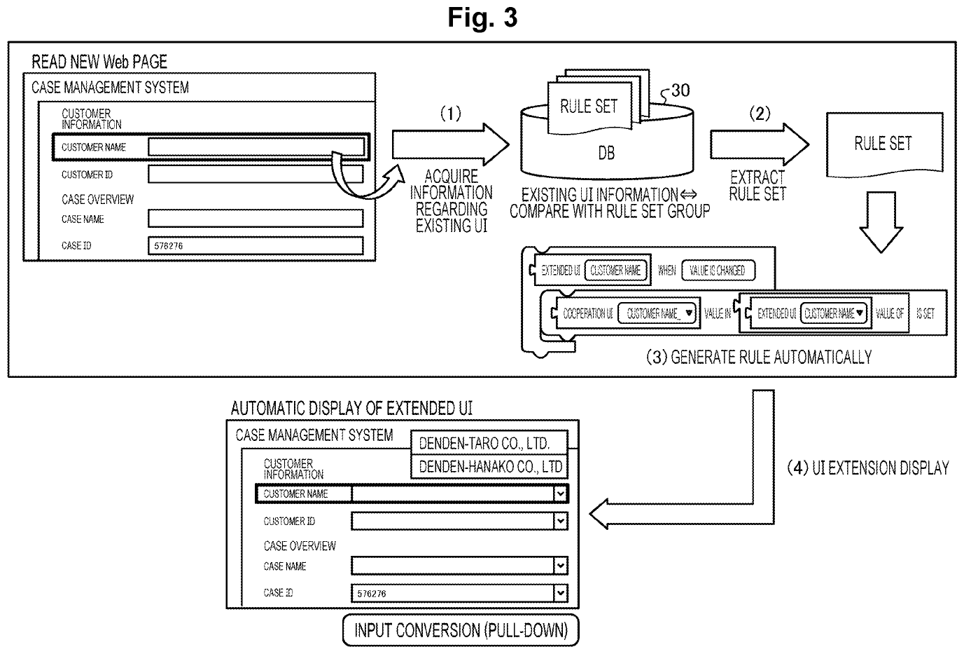

A UI information determination process according to the present embodiment will be described in detail with reference to FIG. 3. FIG. 3 is a diagram illustrating an example of a UI information determination process according to the first embodiment. First, the UI information determination unit 151 of the display control unit 10 reads a new web page and acquires information regarding an existing UI (“existing UI information” as appropriate) (see FIG. 3 (1)). Here, the existing UI information is information such as a UI type (for example, a text box) of a plurality of existing UIs and label information (for example, a customer name) included in the new web page, but the present invention is not particularly limited thereto.

Next, the UI information determination unit 151 compares the existing UI information with the rule set group stored in the database 30 and extracts an appropriate rule set (see FIG. 3 (2)). Here, the rule set is certain existing UI information and information regarding an extended UI associated with the existing UI information. The information regarding the extended UI is information such as a UI type of extended UI (example: pull-down, a button), arrangement information (for example, an object base point), and the like, but the present invention is not particularly limited thereto.

Then, the UI information determination unit 151 generates rule information (“extended UI information” or “rule information” as appropriate) of the extended UI from the extracted rule set (see FIG. 3 (3)). Here, the rule information of the extended UI is information in which information regarding an appropriate extended UI is associated with a plurality of existing UIs of the web page, but the present invention is not particularly limited thereto. Finally, the setting unit 152 of the display control unit 10 performs UI extension display on the read new web page based on the foregoing extended UI information (see FIG. 3 (4)).

### [UI Information Update Processing]

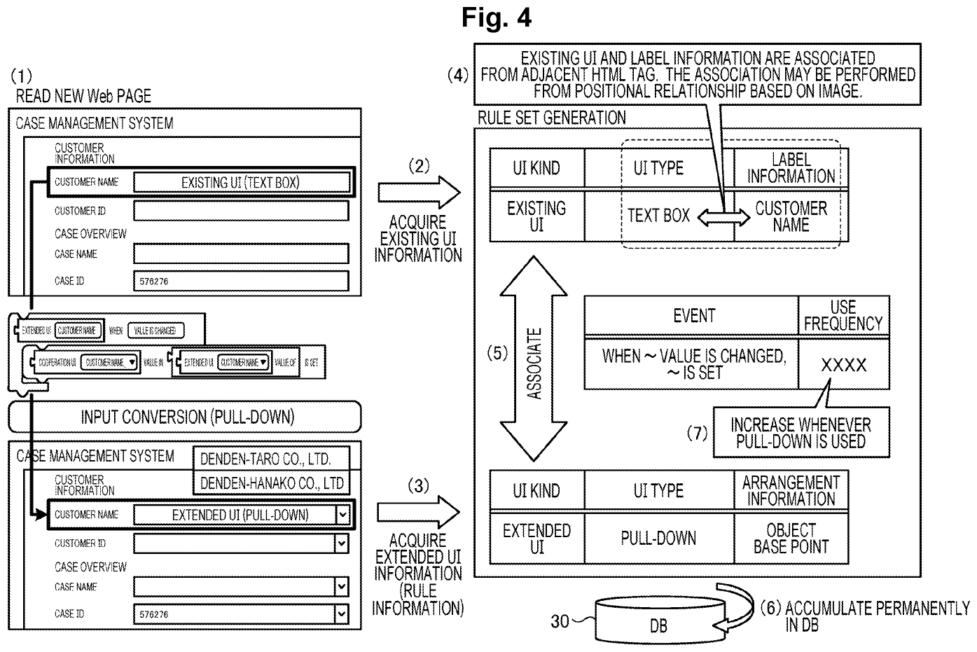

The UI information updating process according to the present embodiment will be described in detail with reference to FIG. 4. FIG. 4 is a diagram illustrating an example of UI information updating process according to the first embodiment. First, the UI information updating unit 151 of the display control unit 10 reads a web page to which the extended UI is applied (see FIG. 4 (1)) and acquires existing UI information (see FIG. 4 (2)). The UI information updating unit 153 acquires the applied extended UI information, that is, the rule information (see FIG. 4 (3))

At this time, the UI information updating unit 153 associates the UI type of existing UI with the label information or the like from an adjacent hypertext markup language (HTML) tag with regard to the acquired information of the existing UI (see FIG. 4 (4)). The UI information updating unit 153 may perform the association from a positional relationship based on an image. In FIG. 4, a UI type “text box” of the existing UI is associated with the label information “customer name.”

Subsequently, the UI information updating unit 153 associates the acquired information of the existing UI with the acquired rule information of the extended UI (see FIG. 4 (5)). In FIG. 4, a UI type “text box” and label information “customer name” which are the information regarding the existing UI are associated with a UI type “pull-down” and arrangement information “object base point” which are the information regarding the extended UI. Information obtained by structuring the relevance between the existing UI and the extended UI generated in this way is set as a rule set.

Then, the UI information updating unit 153 stores the generated rule set in the database 30 (see FIG. 4 (6)). At this time, the UI information updating unit 153 stores the rule set in the database 30 whenever the rule set is generated. Accordingly, the rule set is permanently accumulated in the database 30.

Further, the UI information updating unit 153 can measure the use frequency of the rule set by monitoring the extended UI displayed and used based on the generated rule set (see FIG. 4 (7)). In FIG. 4, since the UI type “pull-down” is applied as the information regarding the extended UI with regard to the label information “customer name” (UI type “text box”) as the information regarding the extended UI, the UI type “pull-down” increases whenever the pull-down of the extended UI displayed based on the rule set is used.

### [Flow of Display Control Process]

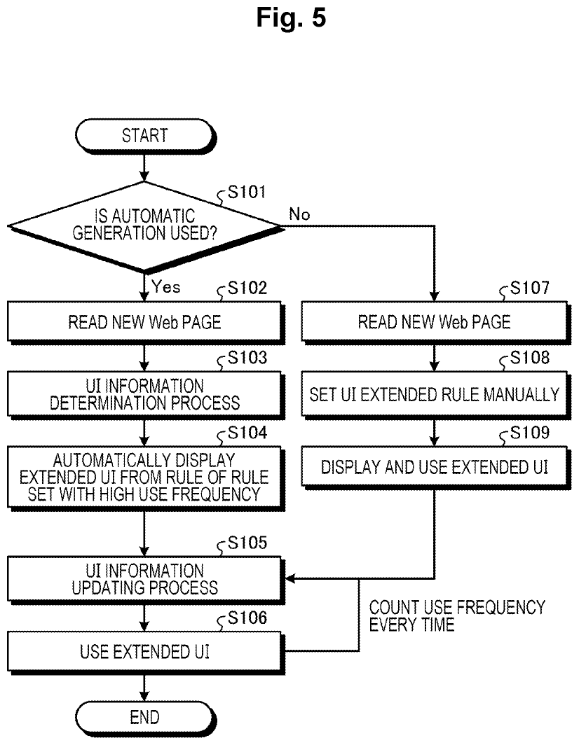

A flow of a display control process according to the present embodiment will be described in detail with reference to FIG. 5. FIG. 5 is a flowchart illustrating an example of a flow of a display control process according to the first embodiment.

First, when the automatic generation process for the extended UI of the display control device 10 is used (Yes in step S101), the UI information determination unit 151 reads a new web page (step S102). Subsequently, the UI information determination unit 151 executes the above-described [UI information determination process] (step S103). That is, firstly, the first acquisition unit 151a acquires the information regarding the existing UI from the new web page. Secondly, the extraction unit 151b extracts a rule set from the predetermined database 30 based on the information regarding the existing UI acquired by the first acquisition unit 151a. Thirdly, the first generation unit 151c generates the rule information of the extended UI based on the rule set extracted by the extraction unit 151b. Subsequently, the setting unit 152 automatically displays the extended UI based on the rule information generated from the rule set of which the use frequency is high (step S104).

At this time, for example, when a use frequency of a rule set in which “pull-down” (an extended UI) is associated with label information “customer name” is “5” as information regarding a certain existing UI, and a use frequency of a rule set in which a “button” (an extended UI) is associated with label information “customer name” is “3” as information of a certain existing UI, a rule set in which “pull-down” of which the use frequency is high is associated is extracted as an appropriate rule set, rule information is generated from the rule set, and the extended UI is displayed from the rule information.

When the result is not uniquely determined (for example, both the use frequencies of the rule sets of the “pull-down” and the “button” are “5”), the setting unit 152 can present operation options (for example, “Pull-down,” “Button,” and “Not display”) to the user 20 so that the user 20 can select the options although each rule is generated. The setting related to the display or the like of the setting unit 152 can be changed statically or dynamically.

Then, the UI information updating unit 153 executes the above-described [UI information updating process] (step S105). That is, firstly, the second acquisition unit 153a acquires the existing UI information and the rule information of the extended UI from the web page. Secondly, the second generation unit 153b generates the rule set based on the existing UI information and the rule information acquired by the first acquisition unit 153a. Thirdly, the storage unit 153d stores the rule set generated by the second generation unit 153b in the predetermined database 30.

Finally, the measurement unit 153c measures the use frequency of the used extended UI, updates the use frequency of the rule set related to the extended UI stored in the database 30, and ends the process (step S106). At this time, the storage unit 153d may measure the use frequency of the rule set and subsequently store the rule set in the database 30.

Conversely, when the automatic generation process of the extended UI of the display control device 10 is not used (No in step S101), the UI information determination unit 151 reads a new web page (step S107). Next, the first generation unit 151c generates the rule information of the extended UI based on the information input by the user 20 via the input unit 11 (step S108). At this time, the first generation unit 151c may generate the rule information of the extended UI based on the input rule set.

Then, the setting unit 152 displays the extended UI based on the generated rule information (step S109). At this time, the setting unit 152 may display the extended UI based on the rule information input by the user 20 via the input unit 11. Further, the measurement unit 153c measures the use frequency of the used extended UI. Finally, the storage unit 153d stores the rule set group to which the use frequency of the rule set related to the extended UI is assigned in the database 30.

### Effects of First Embodiment

Firstly, in the display control process according to the above-described present embodiment, information regarding the existing UI is acquired, a rule set indicating relevance between the existing UI and the extended UI is extracted from a predetermined database based on the acquired information of the existing UI, rule information of the extended UI is generated based on the extracted rule set, and display of the extended UI is set based on the generated rule information of the extended UI. Therefore, in this process, the productivity and efficiency of rule setting of the extended UI can be improved.

Secondly, in the display control process according to the above-described present embodiment, the information regarding the existing UI and the rule information are acquired, the rule set is generated based on the acquired information of the existing UI and the rule information of the extended UI, and the generated rule set is stored in the database. Therefore, in this process, the relevance between the existing UI and the extended UI can be structured and accumulated, and the productivity and efficiency of rule setting of the extended UI can be improved.

Thirdly, in the display control process according to the above-described present embodiment, the use frequency of the rule set is measured based on an operation on the extended UI in which the display is set, and the rule set to which a use frequency of the rule set is assigned is stored. Therefore, in this process, the relevance between the existing UI and the extended UI can be structured and accumulated, and the productivity and efficiency of the rule setting of the extended UI can be more appropriately improved.

Fourthly, in the display control process according to the above-described present embodiment, the rule information of the extended UI is generated based on the rule set to which the use frequency of the rule set equal to or greater than the predetermined value is assigned. Therefore, in this process, the relevance between the existing UI and the extended UI can be structured and accumulated, and the productivity and efficiency of the rule setting of the extended UI can be more appropriately and effectively improved.

Fifthly, in the display control process according to the above-described present embodiment, when the rule information of the generated extended UI is not uniquely determined, non-display of the extended UI or presentation of the selectable extended UI is set. Therefore, in this process, the relevance between the existing UI and the extended UI can be structured and accumulated, and the productivity and efficiency of the rule setting of the extended UI more easily used by the user can be improved.

### [System Configuration and the Like]

Each constituent of each device that has been illustrated according to the foregoing embodiment is functionally conceptual, and does not necessarily have to be physically configured as illustrated. That is, a specific form of distribution and integration of individual devices is not limited to the illustrated form, and all or some of the configurations can be functionally or physically distributed and integrated in any unit according to various loads, use situations, and the like. Further, all or some of the processing functions performed in each device can be implemented by a CPU and a program analyzed and executed by the CPU, or can be implemented as hardware by a wired logic.

Of the individual processes described in the foregoing embodiment, all or some of the processes described as being automatically performed can be manually performed. Alternatively, all or some of the processes described as being manually performed can be automatically performed by a known method. In addition, a processing procedure, a control procedure, a specific name, and information including various types of data and parameters illustrated in the above document and the drawings can be arbitrarily changed unless otherwise specified.

### [Program]

It is also possible to create a program in which a process executed by the display control device 10 described in the embodiment described above is described in a language that can be executed by a computer. In this case, when the computer executes the program, the advantageous effects similar to those of the above-described embodiment can be obtained. Further, the process similar to that of the foregoing embodiment may be implemented by recording the program on a computer-readable recording medium and reading and executing the program recorded on the recording medium in the computer.

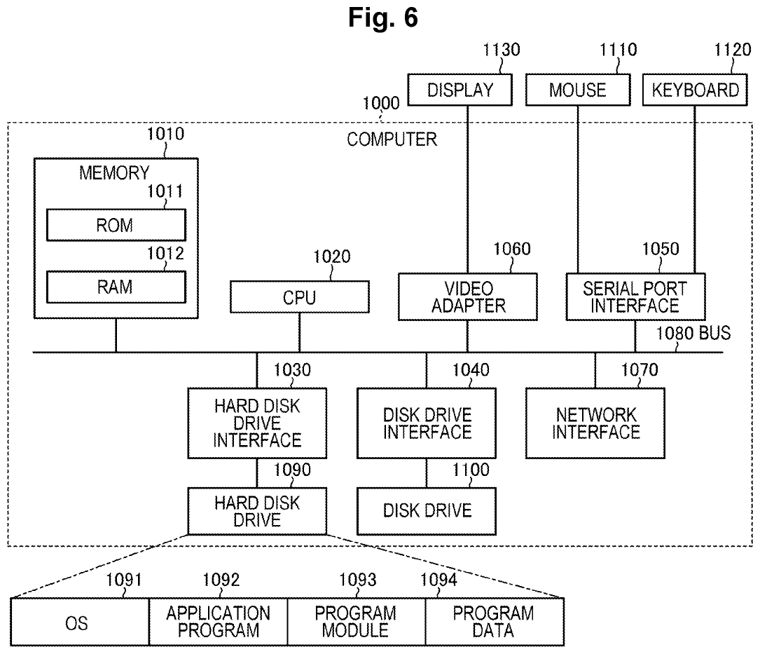

FIG. 6 is a diagram illustrating a computer that executes a program. As exemplified in FIG. 6, a computer 1000 includes, for example, a memory 1010, a CPU 1020, a hard disk drive interface 1030, a disk drive interface 1040, a serial port interface 1050, a video adapter 1060, and a network interface 1070 which are connected by a bus 1080.

As exemplified in FIG. 6, the memory 1010 includes a read-only memory (ROM) 1011 and a RAM 1012. The ROM 1011 stores, for example, a booting program such as a basic input output system (BIOS). The hard disk drive interface 1030 is connected to the hard disk drive 1090 as exemplified in FIG. 6. The disk drive interface 1040 is connected to the disk drive 1100 as exemplified in FIG. 6. For example, a removable storage medium such as a magnetic disk or an optical disc is inserted into the disk drive 1100. As illustrated in FIG. 6, the serial port interface 1050 is connected to, for example, a mouse 1110 and a keyboard 1120. As exemplified in FIG. 6, the video adapter 1060 is connected to, for example, a display 1130.

Here, as exemplified in FIG. 6, the hard disk drive 1090 stores, for example, an OS 1091, an application program 1092, a program module 1093, and program data 1094. That is, the foregoing program is stored, for example, in the hard disk drive 1090 as a program module in which a command executed by the computer 1000 is described.

Various types of data described in the foregoing embodiment are stored as program data in, for example, the memory 1010 and the hard disk drive 1090. Then, the CPU 1020 reads the program module 1093 and the program data 1094 stored in the memory 1010 and the hard disk drive 1090 to the RAM 1012, as necessary, and executes various processing procedures.

The program module 1093 and the program data 1094 related to the program are not limited to being stored in the hard disk drive 1090, and may be stored in, for example, a removable storage medium and may be read by the CPU 1020 via a disk drive or the like. Alternatively, the program module 1093 and the program data 1094 related to the program may be stored in another computer connected via a network (such as local area network (LAN) or a wide area network (WAN)) and read by the CPU 1020 via the network interface 1070.

The foregoing embodiments and modifications of the embodiments are included in the invention described in the claims and the equivalent scope thereof, similarly to being included in the technology disclosed in the present specification.

### REFERENCE SIGNS LIST

10 Display control device
11 Input unit
12 Output unit
13 Communication unit
14 Storing unit
15 Control unit
151 UI information determination unit
151a First acquisition unit
151b Extraction unit
151c Second generation unit
152 Setting unit
153 UI information updating unit
153a Second acquisition unit
153b Second generation unit
153c Measurement unit
153d Storage unit
20 User
30 Database
100 Display control system

1. A display control device comprising:
a first acquisition unit, including one or more processors, configured to acquire information regarding an existing user interface (UI);
an extraction unit, including one or more processors, configured to extract a rule set indicating relevance between the existing UI and an extended UI from a predetermined database based on the information regarding the existing UI acquired by the first acquisition unit;
a first generation unit, including one or more processors, configured to generate rule information of the extended UI based on the rule set extracted by the extraction unit; and
a setting unit, including one or more processors, configured to set display of the extended UI based on the rule information generated by the first generation unit.

2. The display control device according to claim 1, further comprising
a second acquisition unit, including one or more processors, configured to acquire the information regarding the existing UI and the rule information;
a second generation unit, including one or more processors, configured to generate the rule set based on the information regarding the existing UI and the rule information acquired by the second acquisition unit; and
a storage unit, including one or more processors, configured to store the rule set generated by the second generation unit in the predetermined database.

3. The display control device according to claim 2, further comprising:
a measurement unit, including one or more processors, configured to measure a use frequency of the rule set based on an operation to the extended UI of which display is set by the setting unit,
wherein the storage unit is configured to store the rule set to which the use frequency is assigned.

4. The display control device according to claim 3, wherein the first generation unit is configured to generate the rule information based on the rule set to which the use frequency equal to or greater than a predetermined value is assigned.

5. The display control device according to claim 3, wherein the setting unit is configured to set non-display of the extended UI or presentation of the selectable extended UI when the rule information generated by the first generation unit is not uniquely determined.

6. A display control method executed by a display control device, the method comprising:
acquiring information regarding an existing UI;
extracting a rule set indicating relevance between the existing UI and an extended UI from a predetermined database based on the acquired information regarding the existing UI;
generating rule information of the extended UI based on the extracted rule set; and
setting display of the extended UI based on the generated rule information.

7. A display control program causing a computer to execute:
acquiring information regarding an existing UI;
extracting a rule set indicating relevance between the existing UI and an extended UI from a predetermined database based on the acquired information regarding the existing UI;
generating rule information of the extended UI based on the extracted rule set; and
setting display of the extended UI based on the generated rule information.

8. The display control method of claim 6, further comprising:
acquiring the information regarding the existing UI and the rule information;
generating the rule set based on the information regarding the existing UI and the acquired rule information; and
storing the generated rule set in the predetermined database.

9. The display control method of claim 8, further comprising:
measuring a use frequency of the rule set based on an operation to the extended UI of which display is set; and
storing the rule set to which the use frequency is assigned.

10. The display control method of claim 9, further comprising generating the rule information based on the rule set to which the use frequency equal to or greater than a predetermined value is assigned.

11. The display control method of claim 9, further comprising setting non-display of the extended UI or presentation of the selectable extended UI when the generated rule information is not uniquely determined.

12. The display control program of claim 7, further comprising:
acquiring the information regarding the existing UI and the rule information;
generating the rule set based on the information regarding the existing UI and the acquired rule information; and
storing the generated rule set in the predetermined database.

13. The display control program of claim 12, further comprising:
measuring a use frequency of the rule set based on an operation to the extended UI of which display is set; and
storing the rule set to which the use frequency is assigned.

14. The display control program of claim 13, further comprising generating the rule information based on the rule set to which the use frequency equal to or greater than a predetermined value is assigned.

15. The display control program of claim 12, further comprising setting non-display of the extended UI or presentation of the selectable extended UI when the generated rule information is not uniquely determined.
